(19) United States
(12) Patent Application Publication
(10) Pub. No.: US 2011/0069954 A1
(43) Pub. Date: Mar. 24, 2011

(54) On Improved Optical Network Apparatus Having Optical Line Terminal Blade Protection with 1-to-N Redundancy and No-Service-Interruption

(75) Inventors: Junqiang Hu, Princeton, NJ (US); Ting Wang, West Windsor, NJ (US); Dayou Qian, Plainsboro, NJ (US); Philip Nan Ji, Princeton, NJ (US)

(73) Assignee: NEC LABORATORIES AMERICA, INC., Princeton, NJ (US)

(21) Appl. No.: 12/566,317

(22) Filed: Sep. 24, 2009

(51) Int. Cl. H04J 14/00

(52) U.S. Cl. 398/45

(57) ABSTRACT

There is provided an optical network apparatus having interconnected processing gigabit passive optical network G-PON blades, a protection blade, and controller blade, the regular blades and protecting blade having a higher layer processing and switching interface to a G-PON media access control MAC coupled to PHY including serializer and de-serializer modules that are connected to respective interface modules, the improvement including a protecting 1:N signal drive and a protecting N:1 signal select driver coupled between the interface module and serializer and de-serializer modules of the protecting blade, respectively, for protecting connection to the interface module of the protecting blade. The improvement further includes a processing 1:N signal driver and a processing N:1 signal select driver coupled between the interface module and serializer and de-serializer modules of the processing G-PON blade, respectively, for protecting connection to the interface module of the processing G-PON blade and a 1:2 signal driver and 2:1 signal select driver in the interface module for providing an alternative connection to the protection blade.

### BACKGROUND OF THE INVENTION

The present invention relates generally to optical systems, and more particularly, to protection of an optical line terminal in a passive optical network.

Service resilience has always been an area of critical focus for the carriers. Carrier grade equipments require “Five nines” (99.999%) of availability, i.e., about 5 minutes of outage per year. This takes into account all the incidents that could disrupt communications services—hardware failures, fiber cuts, or software failures. So far different solutions have been applied from various aspects: the system is designed with enough redundancy, including key modules redundancy (e.g., control, switching and power supply modules) and operating environment redundancy (e.g., temperature range and electromagnetic interference); the network is deployed with certain protecting schemes, such as ring topology or backup path. Besides the system and network robustness, the recovery time is also critical. The normally required network recovery time is within 50 milliseconds.

Yet for passive optical networks PON and other access systems, most of the research/product efforts for reliable network are generally focused on the network topology and the protect-switching with the specific topology. Though the network-level protection usually provides enough redundancy and enables traffic re-route, in access networks, the proposed solutions are usually not economic, which is a big concern for the carriers. Moreover, with the existing network protection schemes, usually a 1:1 redundancy for the optical line terminal OLT is necessary to enable the protection. So practically there is strong demand to enable the line card protection to improve the access network reliability.

Accordingly, there is a need for a 1-to-N protecting solution from the system level, to improve the system (and thus the network) robustness. Moreover, a “seamless service recovery” scheme is also needed to reduce the recovery time.

### SUMMARY OF THE INVENTION

In accordance with the invention, there is provided an optical network apparatus having interconnected processing gigabit passive optical network G-PON blades, a protection blade, and controller blade, the regular blades and protecting blade having a higher layer processing and switching interface to a G-PON media access control MAC coupled to PHY including serializer and de-serializer modules that are connected to respective interface modules, the improvement including a protecting 1:N signal driver and a protecting N:1 signal select driver (multiplexer) coupled between the interface module and serializer and de-serializer modules of the protecting blade, respectively, for protecting connection to the interface module of the protecting blade. The improvement further includes a processing 1:N signal driver and a processing N:1 signal select driver coupled between the interface module and serializer and de-serializer modules of the processing G-PON blade, respectively, for protecting connection to the interface module of the processing G-PON blade and a 1:2 signal driver and 2:1 signal select driver in the interface module for providing an alternative connection to the protection blade.

### BRIEF DESCRIPTION OF DRAWINGS

These and other advantages of the invention will be apparent to those of ordinary skill in the art by reference to the following detailed description and the accompanying drawings.

FIG. 1 is a diagram of an exemplary 1:N protected system external architecture, with 1(a) showing a dedicated interface blade and 1(b) showing a mid-plane architecture with separated interfaces.

FIG. 2 is a diagram of protecting blade architecture and the connection to interface modules.

FIG. 3 is a diagram of a Gigabit Passive optical network G-PON processing blade and the connection to an interface module.

FIG. 4 is a diagram of a back plane architecture interconnection multiple G-PONs.

FIG. 5 is a diagram of a PON system interconnection architecture with 1-to-N protection capability.

FIG. 6 is a diagram of a PON OLT processing blade architecture with elements for no-service-interruption bring up.

FIG. 7 is a diagram of simplified controller blade architecture. FIG. 8 diagrams the procedures to backup and retrieve necessary information, in accordance with the invention;
8(a) diagramming the procedure for updating the backup entry in the controller blade during operation;
8(b) diagramming the procedure for initial waking up procedure for the protection blade to retrieve the processing state information from the controller blade, from the buffer control unit's point of view; and
8(c) diagramming the protection blade working procedure to retrieve the necessary information from the controller blade, from the buffer control unit's point of view, after 8(a) and 8(b) procedures.

### DETAILED DESCRIPTION

The invention is directed to, for a system architecture, physically separating interface modules from the passive optical network (PON) optical line terminal (OLT) blade, and connecting to the corresponding OLT blade through either the backplane or the midplane. The protection blade has a serial signal connection to all the interface modules. For the interface modules, one serial data connection is to its regular OLT blade and the other is to the protection blade. The signal selection is controlled by the controller blade to select either the regular OLT blade or the protection blade.

For seamless service recovery, besides the OLT's local buffer for the necessary information (e.g., ONU serial number and ONU-ID, security encryption key), the backup copy is saved onto the controller blade. In case an OLT blade failure is encountered, the protection blade will be invoked and connected to the interface module under protection. To enable immediate service recovery the operation state and other necessary information are retrieved from the controller blade. Moreover, to eliminate the ranging process, the whole system uses the same slot synchronization signal provided by the controller blade.

### System External Architecture

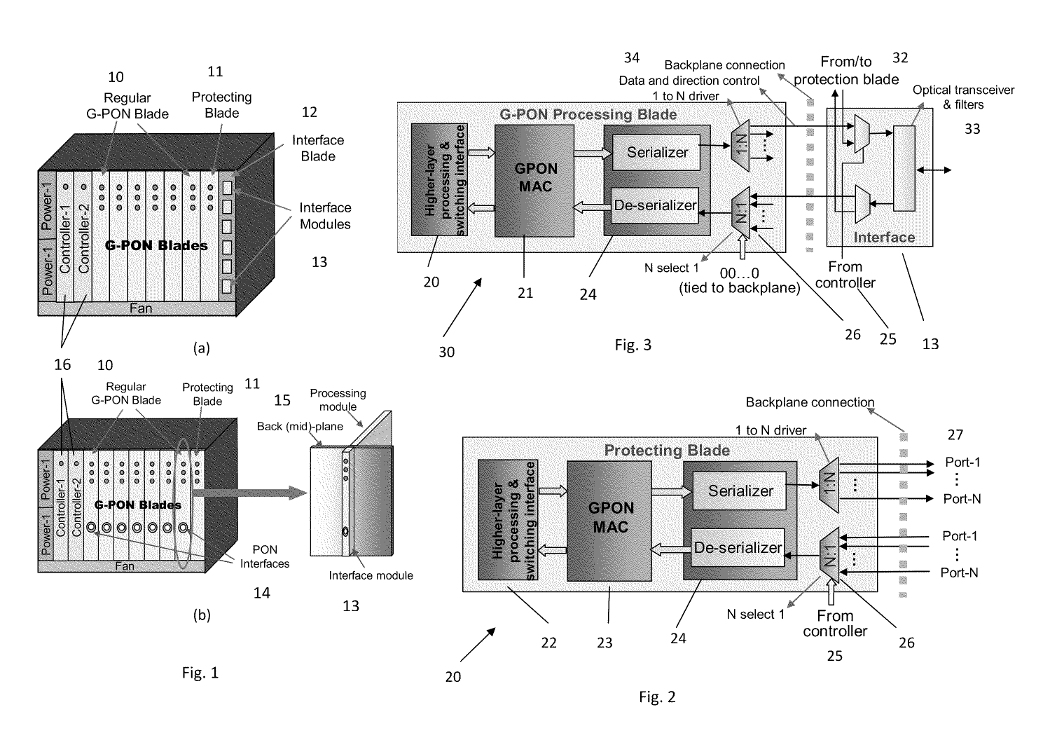

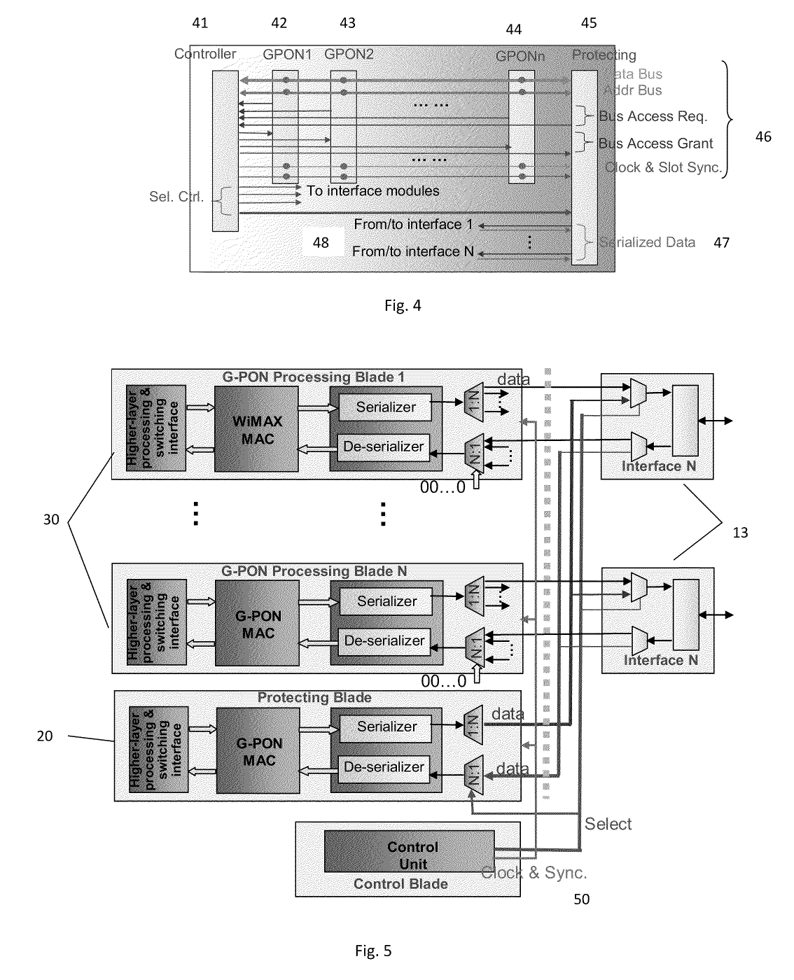

Error! Reference source not found. shows the system external architecture supporting 1-to-N protection for the present invention, using a Gigabit-passive-optical-network G-PON, as an example. The architecture includes G-PON blades 10, protecting blades 11, an interface blade 12, interface modules 13 either on dedicated interface blade 12 (FIG. 1(1)) or in the same slot as G-PON blades 10 (FIG. 1(b)), and midplane or backplane for interconnection. The proposed architecture separates the interface modules 13 from the OLT (processing) blade (or called PON blade). The interface modules 13 are kept as simple as possible, to reduce the failure probability; the main processing functions, including the entire MAC and most of the PHY, remain in the OLT blade. Besides the regular OLT blades, another protecting blade, which is identical to other OLT blades, are provided in the protecting slot.

Two different mechanical approaches are illustrated in Error! Reference source not found.: (a) gives the architecture with dedicated interface slot that accepts the pluggable interface modules; (b) gives the architecture using mid-plane 15, that the interface modules are plugged on the other side of the mid-plane than the OLT processing modules. The differences of Error! Reference source not found. (a) and (b) are only mechanical.

### OLT Blade and Interface Module Architecture

Error! Reference source not found. is a diagram schematic of the protecting blade architecture 20. The “higher-layer processing & switching interface” 22, “GPON MAC” 23 and PHY 24 which mainly include serializer/deserializer and other control functions are the well known modules in the PON OLT system. For conventional OLT blade, the serializer and de-serializer are directly connected to the interface module; yet in the present invention, for the protection blade, a 1:N signal driver and N:1 signal Mux is presented 26, for the protecting connection to the interface modules. The 1:N signal driver duplicates one input signal to N outputs, and each output is connected to an interface module; the N:1 signal Mux is controlled by the selection signal 25 from the controller blade, to select the signal from the interface module that is under protection. The regular OLT is identical to the protection OLT, to simplify the design. Error! Reference source not found. is the regular OLT processing blade and its connection to the interface module. Unlike conventional interfaces, the interface module has a 1:2 signal driver and 2:1 signal select module to provide alternative connection to the protection blade. The processing blade 30 is shown with a detail for the interface module that includes optical transceiver and filter, connection from and to the protection blade 32, and the backplane connection and data and direction control 34.

Error! Reference source not found. is the backplane signal illustration diagram to support the interconnection. The types of slot include controller slot 41, GPON slots 42, 43, . . . 44 and the protecting slot 45. The controller slot 41 includes the following interconnections to or from the GPON slots and/or protecting slot:

Sel. Ctrl.: selection control, to enable the interface module select the signal from either regular blade 10 or the protecting blade 11; Sel. Ctrl.: selection control, to enable the interface module select the signal from either the regular blade 10 or the protecting blade 11. The protecting slot 45 includes the following interconnections:
Data Bus: for memory access and interaction with both GPON slots and protecting slot;
Addr Bus: memory access and other interaction address with both GPON slots and protecting slot;
Bus Access Req.: Data and Addr bus access request, each signal from one dedicated GPON slot or the protecting slot;
Bus Access Grant: Data and Addr bus access grant, each from one dedicated GPON slot or the protecting slot; and
Clock & Slot Sync.: to distribute the clock and GPON slot synchronization signal, to reach system level synchronization and avoid ranging during recovery.
   Besides the interconnection signals to controller blade, protecting blade also includes Serialized data: PHY transmit/receive signal.

The controller slot 41 is for the controller blade 16; the GPON slots are for the regular OLT blade 10, and the protecting slot is for the protection blade 11. “Sel. Ctrl.” is the selection control signal for the N:1 Mux in the protection blade 11, or for the 2:1 Mux in the interface modules; “Serialized data” is serial signals following 1:N driver (for the protection blade), or N:1 Mux (for the protection blade), or 1:2 driver (for the interface modules), or 2:1 Mux (for the interface modules); “Data Bus”, “Addr Bus”, “Bus Access Req”, and “Bus Access Grant” are the signals for fast system recovery (to be introduced in the next section). Error! Reference source not found. is the system level interconnection based on the architecture of the controller blade 16, regular OLT blade 10, protection OLT blade 11, and the interface modules 13.

The “Clock & Sync.” Signals 50 of the control unit in Error! Reference source not found. are for system-level synchronization. The clock is used as a system clock, and the synchronization signal is used for the OLT blades 10 to align the time slot (which is the basic time unit for PON). The purpose is to eliminate the optical network unit ONU ranging process.

### No-Service-Interruption System Recovery

The present invention saves the initial optical network unit ONU registration parameters and the real-time OLT processing states in the controller blade 16, besides the local registers/buffers. The signals between the controller blade 16 and the OLT blades (including both the regular OLT 10 blades and the protection blades 11) include the Data Bus, Addr Bus, Bus Access Req., Bus Access Grant, and other common signals 45. Whenever an OLT blade updates its entry, a corresponding update will be performed in the controller blade 16, through these bus access signals. When OLT blade encounters problem, the protection blade will retrieve the necessary information from the controller blade 16 through these bus signals and continue the normal operation without interrupting the service.

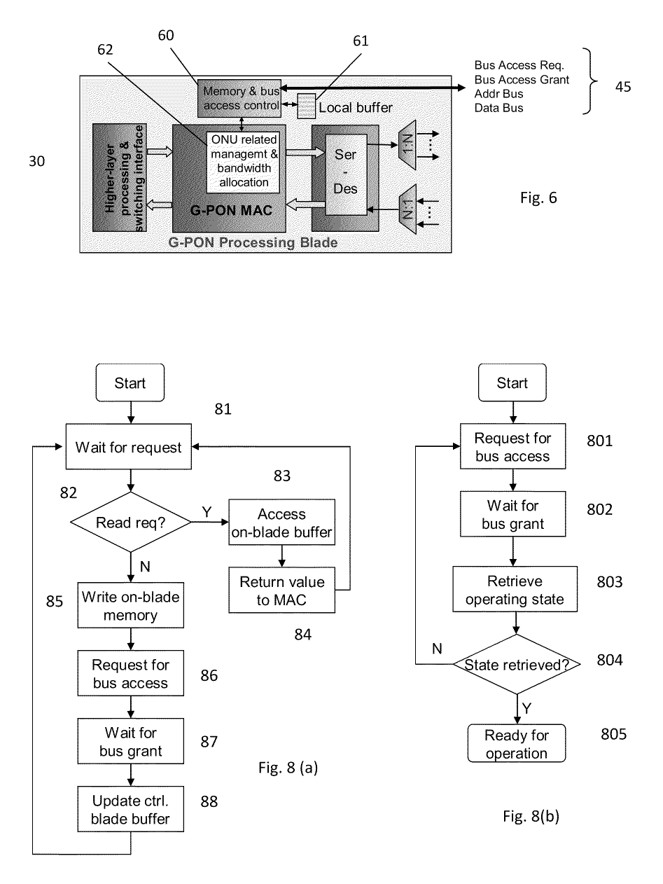

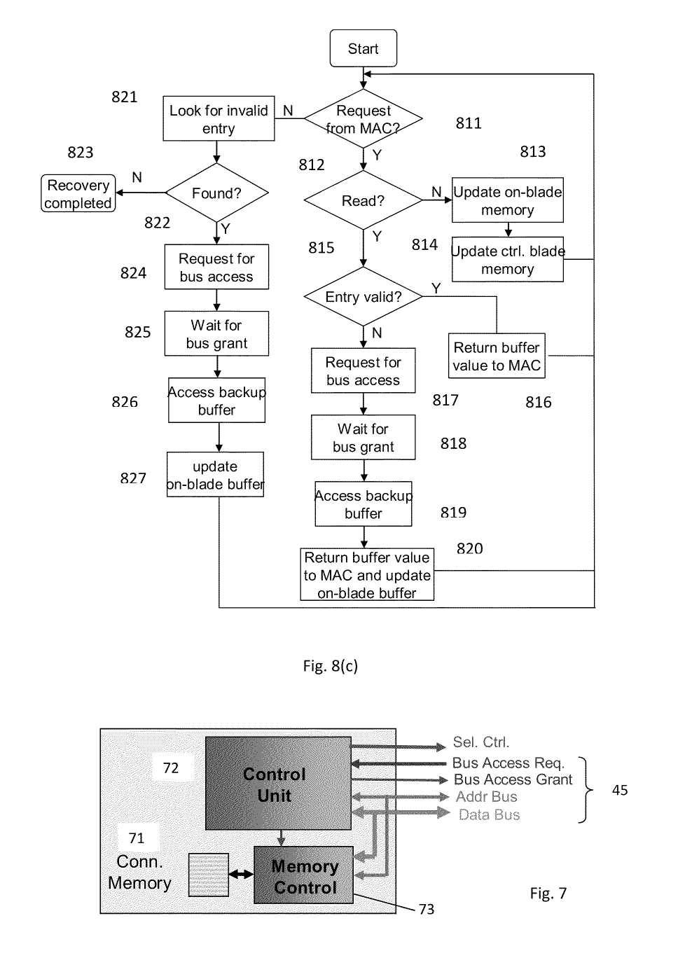

FIG. 6 is a diagram of the OLT blade architecture to support the information backup and retrieving. The local buffer 61 contains the necessary information for OLT operation, such as the ONU properties and the ONU list, the bandwidth requirement from each ONU 62, the current operation status, etc.; the “memory & bus access control” module 60 is responsible for the local buffer management, and updates/retrieves the information to/from the controller blade. FIG. 7 is a diagram of the controller blade interface and modules, including connection memory 71, control unit 72 and memory control, to support this backup/retrieving.

The flow diagrams of FIGS. 8(a), 8(b), and 8(c) give the procedure to backup and retrieve the necessary information. Shown in FIG. 8 (a) is the procedure to update the backup entry in the controller blade, from the “memory & bus access control” (in brief, the buffer control unit) unit's point of view (see FIG. 6), during regular operation. The buffer control unit keeps on waiting for request 81 from the MAC processing unit. Once there is a request, it will check whether it is the read 82 or write request. For read request, it will access the local buffer 83 and return the value to the MAC module 84. For a write operation, it writes the value into the local buffer 85, and in the mean time, it requests for bus access 86 from the controller blade. Once the bus access is granted 87, it writes the info to the corresponding entry in the controller blade 88.

Shown in 8 (b) is the initial waking up procedure for the protection blade to retrieve the processing state information from the controller blade, from the buffer control unit's point of view. Once the controller blade activates the protection blade, the bus access priority for the protection blade is set to the highest. When the protection blade is invoked, it first requests for bus access 801, waits for a bus grant 802, to retrieve the operating state 803. The “operating state” is the operation status (including the necessary state information) of the regular blade 10 (which is now protected) that is saved before the blade fails. The protection retrieves these states to continue from the point when the OLT blade fails. Once the state information is retrieved 804, the protection blade is ready 805 to interact with the ONUs.

Shown in 8 (c) is the protection blade working procedure to retrieve the necessary information from the controller blade, from the buffer control unit's point of view, after that of the procedure shown in FIG. 8 (b). The idea is, whenever the MAC unit in the protection blade requests for data, it will first lookup in the local buffer; if the entry is not valid, it will inquiry the corresponding entry in the controller blade and have that information returned. In case no request is received from the MAC unit, it keeps on copying the entries from the controller blade, to those not valid in the local buffer.

Referring specifically to the flow diagram in FIG. 8(c), the buffer control unit keeps on waiting for request 811 from the MAC processing unit. Once there is a request, a check is made whether it is the read 812 or write request 812, N. For a write request the on-blade memory is updated 813 and then the control blade memory is updated 814. For a read request, the validity of the entry is checked 815. If the entry in the local buffer is valid the buffer value is returned to the MAC module 816. If the entry in the local buffer is not valid then bus access is requested 817 from the controller blade and their si a wait for bus grant 818. Once the bus access is granted the backup buffer is accessed 819 and the buffer value to the MAC and the on-blade buffer is updated 820. Initially, if there is no request 811,N from the MAC processing unit then a lookup is made for a valid entry , which if not found 822,N then the recovery is completed. If the valid entry is found 822,Y then there is a request for bus access 824 and then a wait 825 for a bus grant 802 to access the backup buffer 826. After access to the backup buffer 826, an update to the on-blade buffer is made followed by a return to the request from the MAC processing unit 811.

The present invention has been shown and described in what are considered to be the most practical and preferred embodiments. It is anticipated, however, that departures may be made therefrom and that obvious modifications will be implemented by those skilled in the art. It will be appreciated that those skilled in the art will be able to devise numerous arrangements and variations, which although not explicitly shown or described herein, embody the principles of the invention and are within their spirit and scope.

What is claimed is:

1. An optical network apparatus having interconnected processing gigabit passive optical network G-PON blades, a protection blade, and controller blade, the regular blades and protecting blade having a higher layer processing and switching interface to a G-PON media access control MAC coupled to PHY including serializer and de-serializer modules that are connected to respective interface modules, the improvement comprising:
a protecting 1:N signal drive and a protecting N:1 signal select driver coupled between the interface module and serializer and de-serializer modules of the protecting blade, respectively, for protecting connection to the interface module of the protecting blade.

2. The optical network apparatus of claim 1, further comprising:
a processing 1:N signal driver and a processing N:1 signal select driver coupled between the interface module and serializer and de-serializer modules of the processing G-PON blade, respectively, for protecting connection to the interface module of the processing G-PON blade.

3. The optical network apparatus of claim 2, further comprising:
a 1:2 signal driver and 2:1 signal select driver in the interface module for providing an alternative connection to the protection blade.

4. The optical network apparatus according to claim 1, wherein the 1:N signal driver of the protecting blade duplicates one input signal to N outputs, with each output being connected to an interface module.

5. The optical network apparatus according to claim 1, wherein the N:1 signal select driver of the protecting blade is controlled by a selection signal from the controller blade for selecting the signal from the interface module that is under protection.

6. The optical network apparatus of claim 1, wherein the 1:N signal driver of the processing G-PON blade duplicates one input signal to N outputs, with each output being connected to an interface module.

7. The optical network apparatus of claim 1, wherein the N:1 signal select driver of the processing G-PON blade is controlled by a selection signal from the controller blade for selecting the signal from the interface module that is under protection.

8. The optical network apparatus of claim 1, wherein the processing G-PON blade further comprises a management and memory configuration for enabling saving of initial optical network unit registration parameters and real time optical line terminal OLT processing states in the controller blade.

9. The optical network apparatus of claim 8, wherein the management and memory configuration enables that when a processing G-PON blade updates its entry, a corresponding update will be performed in the controller blade through bus access signals.

10. The optical network apparatus of claim 8, wherein the management and memory configuration enables that when a processing G-PON blade encounters a problem, the protection blade retrieves the necessary information from the controller blade through bus access signals and continues operation without interruption of service.

11. The optical network apparatus of claim 8, wherein the management and memory configuration comprises a local buffer for containing information necessary for OLT operation such as at least one of ONU properties, ONU list, bandwidth requirement from each ONU, and current operation status.

12. The optical network apparatus of claim 8, wherein the management and memory configuration comprises a memory and bus access control for at least one of managing a local buffer with the processing G-PON and update and retrieval of information to and from the controller blade.

13. The optical network apparatus of claim 3, wherein the N:1 signal driver and the 2:1 signal driver comprises a multiplexer.

14. The optical network apparatus of claim 1, wherein the interface module comprises a dedicated slot in a back plane or mid plane of the respective blade that can be used for separating an interface from the processing G-PON blade.

15. The optical network apparatus according to claim 1, wherein the interface module is connectable to one of the protection blade and the processing G-PON blade responsive to the controller blade.

16. The optical network apparatus of claim 1, wherein the 1:N signal driver in the protecting blade enables connecting transmit signals to the interface module.

17. The optical network apparatus of claim 1, wherein the N:1 signal select driver in the protecting blade enables selecting a received signal from a selective interface module.

18. The optical network apparatus of claim 3, wherein the 1:2 signal driver in the interface module enables connecting a received signal to both the processing G-PON blade and protecting blade.

19. The optical network apparatus of claim 3, wherein the 2:1 signal select driver in the interface module enables selecting a transmit signal from one of the processing G-PON blade and protecting blade.

20. The optical network apparatus of claim 8, wherein information is saved in the controller blade as backup.

21. The optical network apparatus of claim 8, wherein the controller blade enables buffer control in the processing G-PON blade.

22. The optical network apparatus of claim 8, wherein the controller blade enables at least one of accepting media access control MAC requests, returns of reading results, updates and backup information in the controller blade.

23. The optical network apparatus of claim 8, wherein the controller blade enables information backup for the processing G-PON blade in the controller.

24. The optical network apparatus of claim 8, wherein the controller blade enables bus access control.
